(19) United States
(12) Patent Application Publication
(10) Pub. No.: US 2015/0365269 A1
(43) Pub. Date: Dec. 17, 2015

(54) USAGE OF MAPPING JUMPER PINS OR DIP SWITCH SETTING TO DEFINE NODE'S IP ADDRESS TO IDENTIFY NODE'S LOCATION

(71) Applicant: HON HAI PRECISION INDUSTRY CO., LTD., New Taipei (TW)

(72) Inventor: CHUNG-JEN HSIEH, New Taipei (TW)

(21) Appl. No.: 14/307,266

(22) Filed: Jun. 17, 2014

(51) Int. Cl. H04L 12/24

(52) U.S. Cl. CPC H04L 41/0226; H04L 41/0246

(57) ABSTRACT

A method for identifying the location of a server node in a cloud computing room includes determining IO level definition of IO ports according to an IP-Mapping table containing a physical location, an IP address, and an IO level definition for each server node, powering on all the server nodes, retrieving the IO level definition from high/low states of the IO ports, defining the IP address according to the IO level definition retrieved and the IP-Mapping table, detecting hardware or software errors and sending event alert messages when errors are detected in a particular server node, reinstalling or resetting the particular server node when diagnosing, and locating the server node from the IP address of the particular server node and the IP-Mapping table.

### FIELD

The subject matter herein generally relates to a method for identifying node location in a large-scale cloud computing control room.

### BACKGROUND

In a data center or a large-scale cloud-computing room, servers are used to collect and process data. The continued rise and importance for data processing and storage for accommodating the needs of many such as social community sites and government and financial services demand more and more servers to be implemented in these cloud-computing rooms. A rack is often used to accommodate a large number of servers and each cloud-computing room can accommodate a multitude of racks.

### BRIEF DESCRIPTION OF THE DRAWINGS

Implementations of the present technology will now be described, by way of example only, with reference to the attached figures, wherein:

FIG. 1 is a schematic layout of an embodiment of racks in a cloud-computing room.

FIG. 2 is a block diagram of an embodiment of a server node in the rack.

FIG. 3 is a schematic of an embodiment of an I2C-to-GPIO expander.

FIG. 4 is a flow chart of an embodiment of a method for identifying node locations.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to data centers or large-scale cloud-computing rooms.

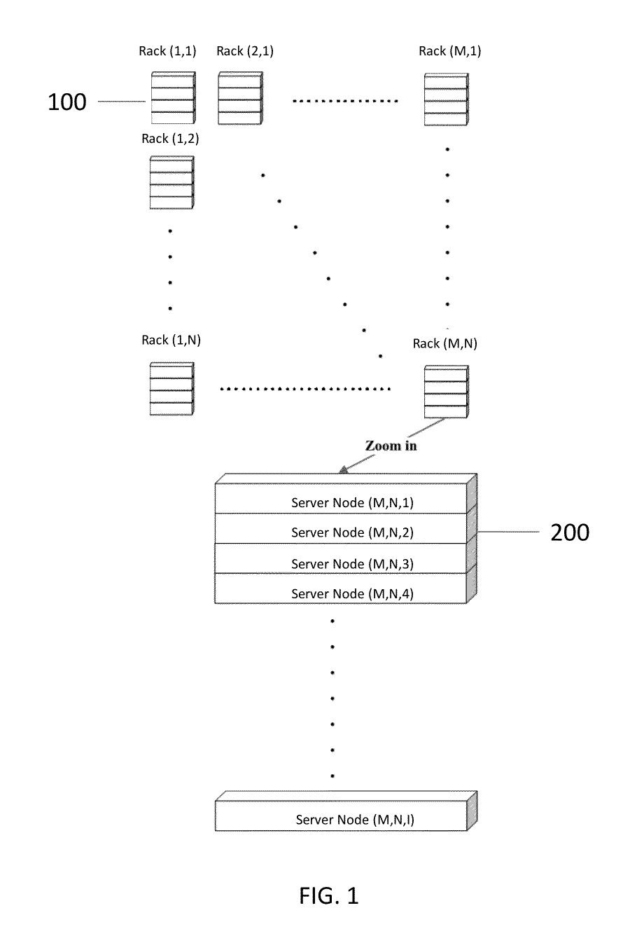

FIG. 1 illustrates an embodiment of a cloud-computing room layout. Each cloud-computing room contains a plurality of racks 100 arranged in an (M×N) matrix, and m and n are positive integers. Each rack 100 can be identifiable by its location in the (M×N) matrix. For example, one rack 100 can be identified as Rack (1, 1) and another as Rack (2,1) located adjacent to Rack (1,1). Each rack 100 contains a plurality of server nodes 200. Each server node 200 can be identified by the rack 100 containing the server node 200 and the location of the server node 200. For example, the server nodes 200 in each rack 100 can be arranged in an array and identifiable as Server Node (M, N, I) in which M and N refer to the specific rack 100, I refers to the specific sever node 200 in the rack 100, and I is a positive integer.

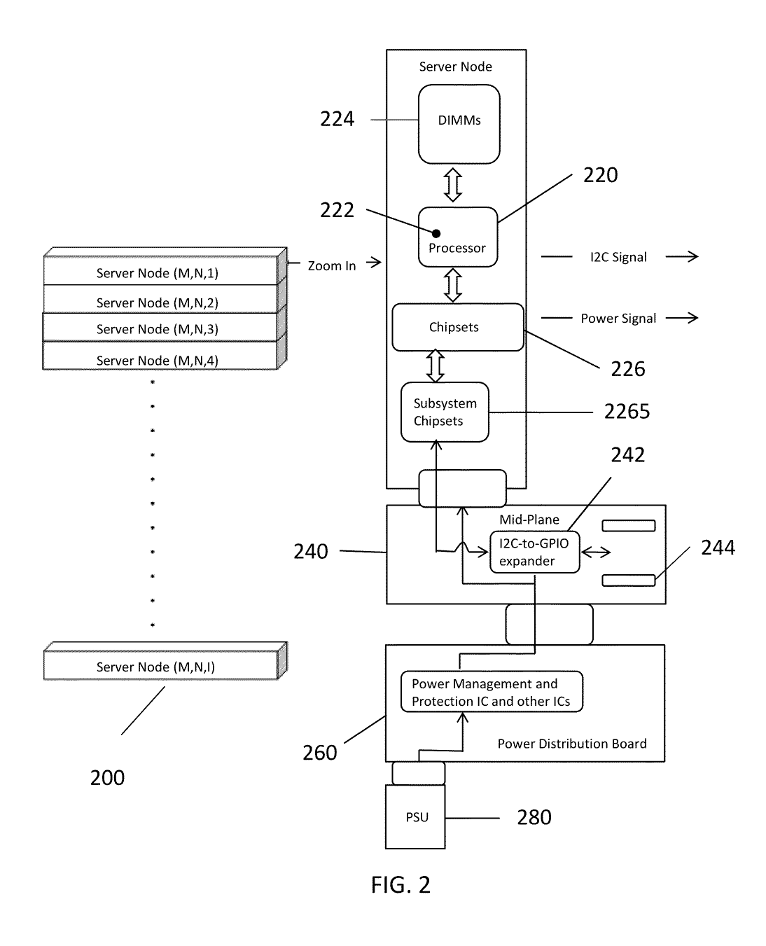

FIG. 2 illustrates an embodiment of a server node 200 in a rack 100. Each server node 200 includes a server motherboard 220, a mid-plane board 240, a power distribution board (PDB) 260, and a power supply unit (PSU) 280. Each server node can also include hardware modules (not shown) and mechanical components (not shown). The mid-plane board 240 can be coupled to the server motherboard 220, the PDB 260 can be coupled to the mid-plane board 240, and the PSU 280 can be coupled to the PDB 260.

The server motherboard 220 includes a central processing unit (CPU) 222, a plurality of dual in-line memory modules (DIMMs) 224, a plurality of chipsets 226, and other peripheral components 228.

The plurality of chipsets 226 includes a platform controller hub (PCH) (not shown) and a server node management controller 2265. The server node management controller 2265 can be a baseboard management controller (BMC). The server node management controller can retrieve the IO level definition from the high/low states of IO ports of an inter-integrated circuit to a general-purpose input/output (I2C-to-GPIO) expander 242. The I2C-to-GPIO expander 242 can be mounted on the mid-plane board 240 or other hardware module through an I2C interface.

The IO level definition from the high/low states of the IO ports of the The I2C-to-GPIO expander 242 are decided by jumper pins 244 or dual in-line package (DIP) switch on the mid-plane board 240 or other hardware module. The jumper pins 244 or DIP switch are visible and easy to operate for IT administrators or users.

After the server node management controller 2265 retrieves the IO level definition, the server node management controller 2265 looks up a pre-defined IP-mapping table to acquire the IP address of the server node 200.

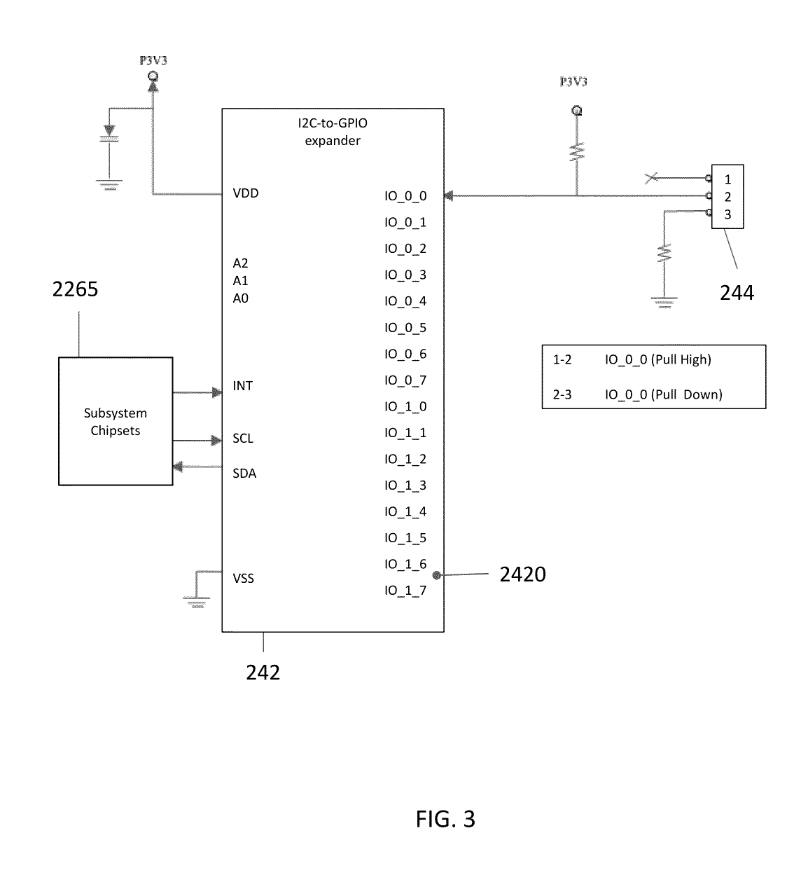

FIG. 3 illustrates a schematic of an embodiment of connections to the I2C-to-GPIO expander 242. The I2C-to-GPIO expander 242 can have a plurality of IO ports 2420, a plurality of address inputs A0, A1, A2, a supply voltage VDD, a supply ground VSS, an interrupt output INT, a serial clock line SCL, and a serial data line SDA. The supply voltage VDD can be connected to an electric imp module breakout P3V3 and to ground through a capacitor. The supply ground VSS is connected to ground. The interrupt output INT, the serial clock line SCL, and the serial data line SDA can be connected to the server node management controller 2265 or other management chips.

Each IO port can be connected to a jumper pin 244 or DIP switch, and can also be connected to the electric imp module breakout P3V3 through a resistor.

Table 1 is an example of the IP-Mapping table which contains the physical location (M, N, I) of the server node 200 in the cloud-computing room, IP address of the server node 200, and IO level definition. The IP address range can be defined by an IT administrator or any user. The IO level definition represents the high/low states of the IO ports 2420 of the I2C-to-GPIO expander 242.

TABLE 1
IP-Mapping Table

| Physical Location | IP address of server node | IO level definition |
|---|---|---|
| (1, 1, 1) | 192.168.1.1 | 0000000000000001 |
| (1, 1, 2) | 192.168.1.2 | 0000000000000010 |
| (1, 1, 3) | 192.168.1.3 | 0000000000000011 |
| (M, N, I) | XXX.XXX.X.X | XXXXXXXXXXXXXXXX |

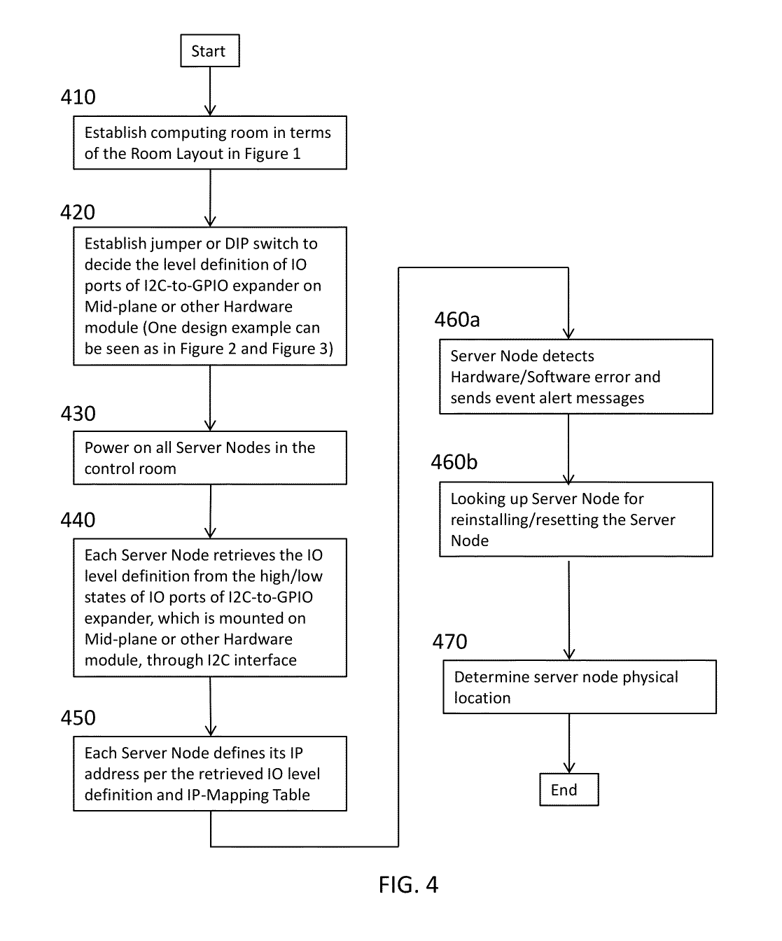

In FIG. 4, a flowchart is presented in accordance with an example embodiment which is being thus illustrated. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 3 represents one or more processes, methods or subroutines, carried out in the method. Additionally, the illustrated order of blocks is by example only and the order of the blocks can change according to the present disclosure. The method can begin depending on one of many conditions.

In block 410, a cloud-computing room is laid out. The cloud-computing room can be laid out in an (M×N) matrix as illustrated in FIG. 1. However, the layout of the racks 100 can be in any arrangement such as accommodating for the size and shape of the cloud-computing room. The method continues to block 420.

In block 420, a user or IT administrator sets up the jumper pins 244 or DIP switch to decide the IO level definition of the IO ports 2420 of the I2C-to-GPIO expander 242 according to the IP-Mapping table. The method then continues to block 430

In block 430, the IT administrator powers on all the server nodes 200 in the cloud-computing room. The method then continues to block 440.

In block 440, each server node 200 retrieves the IO level definition from the high/low states of the IO ports 2420 of the I2C-to-GPIO expander 242. The method then continues to block 450.

In block 450, each server node 200 defines the IP address according to the IO level definition retrieved and the IP-Mapping table. The method then continues to block 460.

In block 460a, when one of the server node management controller 2265 detects hardware or software errors, the server node management controller 2265 sends event alert messages to the IT administrator to correct the error. In addition, in block 460b, the IT administrator can look up a particular server node 200 for reinstalling or resetting that server node 200. The method then continues to block 470.

In block 470, the IT administrator can determine the physical location of the server node 200 that detected the hardware of software error from IP address of that server node 200, the room layout, and the IP-Mapping table.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for identifying the location of a server node in a cloud computing room, the method comprising:
providing a plurality of racks in the cloud-computing room, each rack containing a plurality of server nodes, each server node comprising a server motherboard, a mid-plane board coupled to the server motherboard, a power distribution board (PDB) coupled to the mid-plane board, the server motherboard comprising a servo node management controller, the mid-plane board comprising an I2C-to-GPIO expander, the I2C-to-GPIO expander comprising a plurality of IO ports;
determining an IO level definition of the IO ports according to an IP-Mapping table, the IP-Mapping table having a physical location, an IP address, and an IO level definition for each server node;
powering on all the server nodes;
retrieving the IO level definition from high/low states of the IO ports;
defining the IP address according to the IO level definition retrieved and the IP-Mapping table;
detecting hardware or software errors and sending event alert messages when errors are detected in one or more server nodes;
remotely identifying a particular server node when servicing the particular server node; and
locating the server node from the IP address of the server node and the IP-Mapping table.

2. The method of claim 1, wherein the racks are arranged in the cloud-computing room in an (M×N) matrix, M and N are positive integers, each rack is identifiable by its location in the (M×N) matrix, the server nodes in each rack are arranged in an array and identifiable by location the server nodes in the array and the rack.

3. The method of claim 1, wherein the server node management controller is a baseboard management controller (BMC).

4. The method of claim 1, wherein the servo node management controller retrieves the IO level definition from high/low states of the IO ports.

5. The method of claim 4, wherein the IO level definition of the IO ports are determined by jumper pins or DIP switches on the mid-plane board.

6. The method of claim 5, wherein the server node retrieves the IO level definition from high/low states of the IO ports.

7. The method of claim 6, wherein the server node management controller defines the IP address according to the IO level definition retrieved and the IP-Mapping table

8. The method of claim 7, wherein each IO port is connected to a corresponding jumper pin or DIP switch.

9. The method of claim 1, wherein the server node management controller detects hardware or software errors and sends event alert messages when errors are detected.

10. A server node locating system for a cloud computing room, the system comprising a plurality of racks in the cloud-computing room, each rack containing a plurality of server nodes, each server node comprising a server motherboard, a mid-plane board coupled to the server motherboard, a power distribution board (PDB) coupled to the mid-plane board, the server motherboard comprising a servo node management controller, the mid-plane board comprising an I2C-to-GPIO expander, and the I2C-to-GPIO expander comprising a plurality of IO ports, wherein when all the server nodes are powered on, an IO level definition from high/low states of the IO ports are retrieved, the IP address is defined according to the IO level definition retrieved and the IP-Mapping table; when hardware or software errors are detected, event alert messages are sent; when diagnosing the system the particular server nodes are reinstalled or resetted; and the server node is located from the IP address of the particular server node and the IP-Mapping table.

11. The server node locating system of claim 10, wherein the racks are arranged in the cloud-computing room in an (M×N) matrix, M and N are positive integers, each rack is identifiable by its location in the (M×N) matrix, the server nodes in each rack are arranged in an array and identifiable by location the server nodes in the array and the rack.

12. The server node locating system of claim 10, wherein the server node management controller is a baseboard management controller (BMC).

13. The server node locating system of claim 10, wherein the servo node management controller retrieves the IO level definition from high/low states of the IO ports.

14. The server node locating system of claim 13, wherein the IO level definition of the IO ports are determined by jumper pins or DIP switches on the mid-plane board.

15. The server node locating system of claim 14, wherein the server node retrieves the IO level definition from high/low states of the IO ports.

16. The server node locating system of claim 15, wherein the server node management controller defines the IP address according to the IO level definition retrieved and the IP-Mapping table.

17. The server node locating system of claim 16, wherein each IO port is connected to a corresponding jumper pin or a DIP switch.

18. The server node locating system of claim 10, wherein the server node management controller detects hardware or software errors and sends event alert messages when errors are detected.
